(19) United States
(12) Patent Application Publication
(10) Pub. No.: US 2012/0157603 A1
(43) Pub. Date: Jun. 21, 2012

(54) THERMOPLASTIC ELASTOMERIC MULTIBLOCK COPOLYMERS OF ISOBUTYLENE AND NORBORNENE

(76) Inventors: Joseph P. Kennedy, Akron, OH (US); Ralf M. Peetz, Staten Island, NY (US)

(21) Appl. No.: 13/329,870

(22) Filed: Dec. 19, 2011

Related U.S. Application Data
(63) Continuation of application No. 10/561,705, filed on May 18, 2006, now abandoned.

(51) Int. Cl. C08F 279/00; C09D 145/00; C09J 145/00

(52) U.S. Cl. 524/532; 525/290

(57) ABSTRACT

A composition of matter including a polyisobutylene segment and a polycycloolefin segment. The polyisobutylene segment and the polycycloolefin segment form a repeating unit multiblock copolymer. A method of forming a composition of matter that includes a polyisobutylene segment and a polycycloolefin segment.

### RELATED APPLICATIONS

This application is a continuation application of U.S. patent application Ser. No. 10/561,705 filed on Dec. 22, 2005, which is a 371 national application of PCT Application No. PCT/US04/21320 filed Jul. 1, 2004, now abandoned and claims the benefit of provisional U.S. application Ser. No. 60/484,170, filed Jul. 1, 2003, now abandoned.

### FIELD OF THE INVENTION

The present invention pertains generally to multiblock copolymers, and, more particularly, to linear aliphatic polycyclic-olefin copolymers that can form arms that extend from an aromatic core as part of a multi-arm star composition of matter. Each block copolymer comprises a polyisobutylene segment block polymerized with at least one polycycloolefin segment.

### BACKGROUND OF THE INVENTION

There are a wide variety of known linear triblock thermoplastic elastomers including a polyisobutylene (“PIB”) segment. It is generally recognized, however, that star-configured molecules often exhibit more advantageous viscosity properties and mechanical properties than linear triblock molecules.

Similarly, the synthesis and properties of PIB-based linear and three-arm star thermoplastic elastomers are well known. Such compositions of matter possess properties that make them well adapted for applications such as architectural sealants, thermoplastic elastomers, and coatings for medical devices. However, there is a lack of information on block copolymers that combine soft, rubbery PIB segments with hard, high T_{g} segments of cycloaliphatic polyolefins.

Block copolymers comprising soft and hard segments are of great current interest for gaining insight into the structure/property relationship of segmented polymers in general and thermoplastic elastomers (“TPEs”) in particular. Because of their rigid repeat structures, polycycloolefins exhibit a combination of desirable properties. Among those properties are included useful chemical resistance, high heat distortion temperature, stiffness and strength, optical transparency, and low dielectric constants. These properties are desirable of a composition of matter used in the production of lenses, compact discs, waveguides, photoresists, electronic packaging, medical applications, potential solar energy storage devices, and integrated circuits.

Accordingly, there is a need in the art for a multiblock copolymer comprising a PIB segment and at least one additional segment that includes a cycloaliphatic-polyolefin derivative. The multiblock copolymer should be capable of being cationically synthesized, and should be useful in the synthesis of an aliphatic multi-arm star-block copolymer.

### SUMMARY OF THE INVENTION

In accordance with one general aspect of the invention, there is provided a composition of matter comprising a polyisobutylene segment and a polycycloolefin segment, wherein the polyisobutylene segment and the polycycloolefin segment form a repeating unit multiblock copolymer, wherein the polycycloolefin segment is selected from the group consisting of:

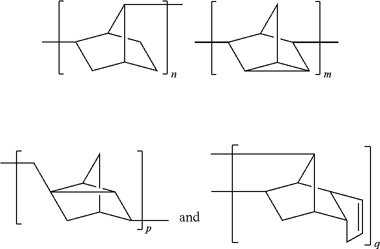

wherein n, m, p and q are all independently-selected integers that are at least 1.

In accordance another general aspect of the invention, there is provided a method of preparing a composition of matter, the process comprising the steps of providing a bifunctional aromatic core; reacting the bifunctional aromatic core with isobutylene to form a macroinitiator having two arms, said macroinitiator comprising polyisobutylene functionalized at the terminus of each arm; transforming the terminus of each arm of the macroinitiator to introduce an active site capable of initiating cationic polymerization of block polymer segments at the terminus of each arm; and initiating cationic polymerization to form the block polymer segments of each arm, thereby forming a two-arm star composition of matter having two multiblock arms.

These and other aspects of the invention are herein described in detail, with reference to the accompanying drawings and examples, which are representative of ways in which the concepts of the invention may be practiced.

### BRIEF DESCRIPTION OF THE DRAWINGS

FIG. 1A is a number-average molecular weight v. conversion curve (top), and an inset Mw/Mn v. conversion curve;

FIG. 1B is an ln([M]o/[M]) v. time curve; and

FIG. 2 is a graph of the Tg of PNBD as a function of 1/Mn.

### DETAILED DESCRIPTIONS OF PREFERRED AND ALTERNATE EMBODIMENTS

Generally, the present invention is directed toward a novel multiblock copolymer, and a multi-arm star block copolymer comprising an aromatic core having one or more arms extending therefrom. Each arm of the present invention comprises the novel multiblock copolymer synthesized by a living cationic-polymerization method, and an arm-terminating functional group.

Each arm extending from the aromatic core of the star-block copolymer further comprises an inner segment formed from a cationic polymerizable monomer, such as an isobutylene derivative.

The term “Mₙ” is used throughout this specification to refer to the number-average molecular weight of the two-arm star compositions of matter, or constituents of the two-arm stars, such as the core, the macroinitiators, or the multiblock arms. Unless specified otherwise, the number-average molecular weight is expressed in units of g/mol.

The term “M_{w}” is used throughout this specification to refer to the weight-average molecular weight, and unless otherwise specified, is also expressed in units of g/mol.

The term “Mw/Mn” is used throughout this specification to refer to the molecular-weight distribution.

The phrase “additional segment” is used interchangeably herein with the phrase “hard segment” to reference materials that have a glass-transition temperature (“T_{g}”) above room temperature.

The symbol “Ø” is used throughout this specification to represent an aromatic core.

In a preferred embodiment, the present invention provides a composition of matter comprising at least one polyisobutylene (“PIB”) segment and at least one hard polycycloolefin segment, wherein said PIB segment and said polycycloolefin segment form a repeating unit multiblock copolymer, wherein the polycycloolefin segment is independently selected from the group consisting of:

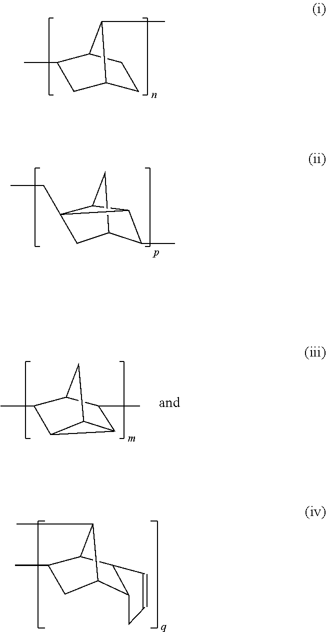

wherein n, m, p and q are all independently-selected integers that are at least 1. Formula (i) represents polynorbornene (“PNB”); formula (II) represents polynorbornadiene (“PNBD”); formula (iii) and formula (iv) represent a first PNBD-derivative and a second PNBD-derivative, respectively. The PIB and the polycycloolefin segment can be arranged in any desired order forming a linear, aliphatic block arrangement, including a preferred alternating-block arrangement represented by the formula:

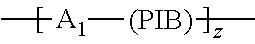

and a more preferred alternating-block arrangement represented by the formula:

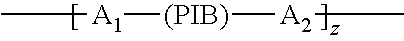

wherein Z is an integer that is at least 1, and wherein A₁ and A₂ each represent a polycycloolefin segment independently selected from the group of formulas (i)-(iv) shown above. Preferably, the polycycloolefin segments A₁ and A₂ are the same.

The relative concentration of the polycycloolefin segments and the PIB segments in the multiblock copolymer of the present invention can be controlled to provide the resulting multiblock copolymer with desired properties. Nonlimiting examples of controllable properties include the elasticity of the multiblock copolymer, adhesive properties, thermal properties, and the solubility of the multiblock copolymer.

In preparing the multiblock copolymer of the present invention, the polycycloolefin segment incorporated into the multiblock copolymer depends upon the monomer unit selected. The predominant polycycloolefin segment included in the multiblock copolymer is related to the monomer unit selected according to the following relationship:

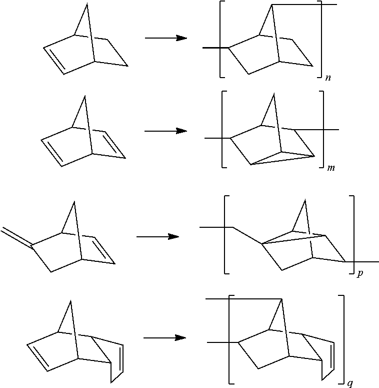

The multiblock copolymer of the present invention can form arms that extend from an aromatic core, thereby forming a multi-arm star composition of matter. Formation of the arms from the aromatic core can be accomplished by living cationic polymerization, commonly referred to as blocking, the polycycloolefin segments and the PIB segments from a suitably-functionalized aromatic core. The core can be mono, di, and tri functional, said core being represented by the respective formulas:

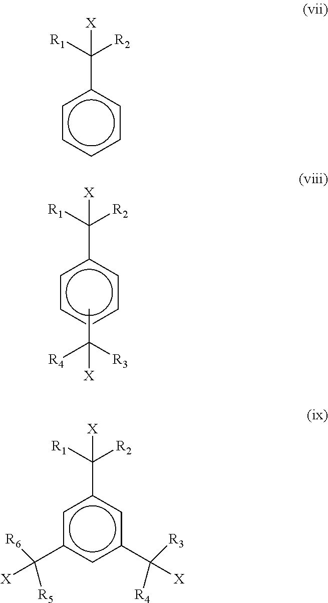

wherein R₁-R₆ are each independently selected from the group consisting of hydrogen, a methyl group, an ethyl group, and a phenyl group; wherein X is selected from the group consisting of —Cl, —Br, —OH, —OCH₃, —OCH₂CH₃, and —OCOCH₃.

Each arm can include the same combination of the PIB segment and the polycycloolefin segments, or, the arms can include different combinations of the PIB segment and the polycycloolefin segments. Preferable embodiments of a two-arm star composition of matter comprising an aromatic core include those represented by the formulas:

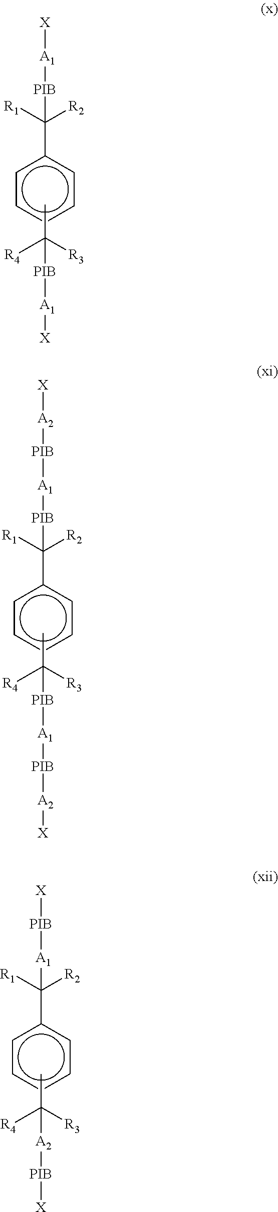

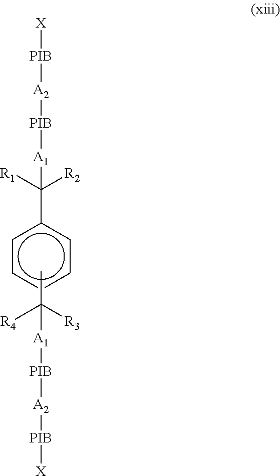

wherein PIB represents a repeating polyisobutylene segment having the formula:

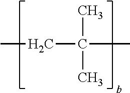

and wherein b is an integer that is at least 1. One arm of the two-arm star copolymer is shown in the loose position, indicating that this arm can be formed to extend from any carbon included in the ring of the aromatic core. However, a preferred embodiment includes the arm in the loose position extending from the para position. Similarly, three-arm star block copolymers are also within the scope of the present invention, preferred embodiments of which are represented by the following formulas:

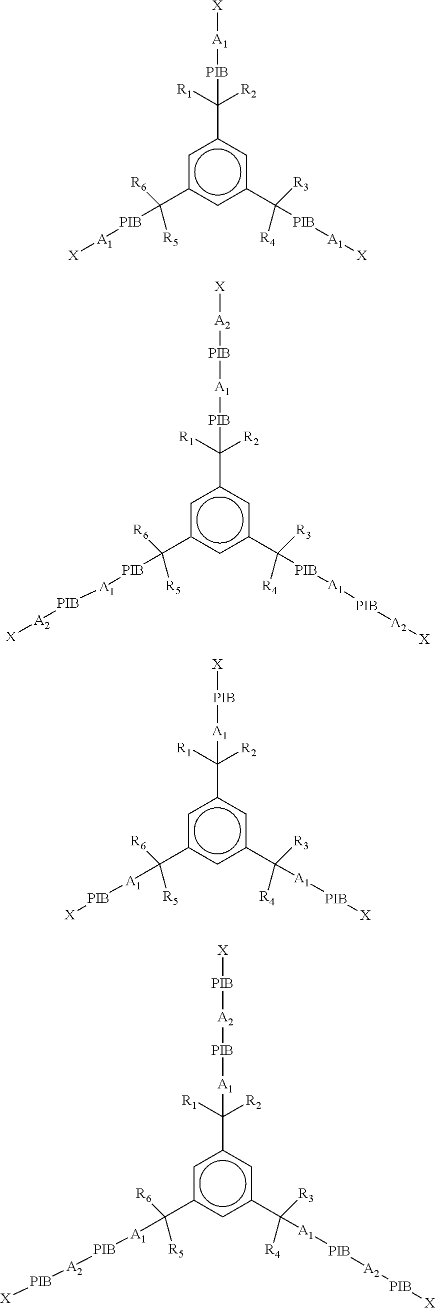

A method for preparing the linear multiblock copolymer of the present invention includes the steps of introducing a functional site to the isobutylene monomer unit or the cycloolefin monomer unit, initiating living cationic polymerization of the functionalized monomer unit, and initiating living cationic polymerization of the unfunctionalized monomer unit to form at least a diblock copolymer. Further steps include the living cationic polymerization of at least one of the isobutylene monomer unit ant the cycloolefin monomer unit to form a triblock copolymer. Regardless of the number of blocks forming the copolymer, the resulting copolymer should be an aliphatic copolymer of a PIB segment and a polycycloolefin segment.

The present invention also provides a method for preparing a star composition of matter, the method comprising the steps of providing a multifunctional aromatic core. The multifunctional aromatic core is provided with a PIB segment at each functional site of the aromatic core to form a macroinitiator having one or more arms, said macroinitiator comprising PIB functionalized at the terminus of each arm. The functionalized terminus of each arm of the macroinitiator is transformed to introduce an active site capable of initiating living cationic polymerization of a polycycloolefin segment and a PIB segment at the terminus of each arm. Cationic polymerization is initialized in the appropriate order to form the desired block polycycloolefin and PIB segments of each arm, thereby forming a multi-arm star composition of matter having one or more arms comprising repeating multiblock polymer units. As mentioned above, preferred multiblock copolymers include diblock copolymers and triblock copolymers.

According to a preferred method of preparation, the aromatic core is a difunctionalized core such as that shown above in formula (vii), having two —Cl^{t} functionalities, wherein one —Cl^{t} functionality is provided to the terminus of each arm. Similarly, according to another preferred method of preparation, the aromatic core is a trifunctionalized core such as that shown above in formula (ix), having three —Cl^{t} functionalities, wherein one —Cl^{t} functionality is provided to the terminus of each arm. The desired copolymer of the arms that are to form the star composition of matter dictates the polymerization sequence that follows. For example, a PIB segment can be cationically polymerized at the functional terminus of each arm, thereby forming a —Cl^{t} ditelechelic PIB (“dCum(PIB-Cl^{t}”) core. Thereafter, a desired polycycloolefin segment can be cationically polymerized, or blocked, from the dCum(PIB-Cl^{t})₂ core, followed by the living polymerization of any further desired segments. Each arm of the desired star composition of matter can be end capped with a suitable arm-termination group, represented generally by the symbol X in the formulas above. In order to better understand the polymerization strategy for an embodiment of the present invention, the following reaction scheme (Identified as Scheme 1) used to form dCum(PIB-b-PNBD-Cl) is provided:

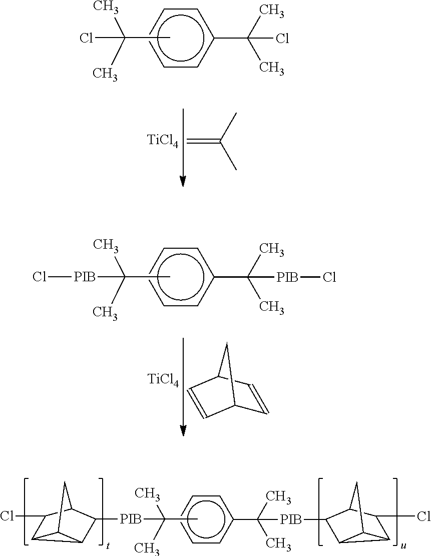

This reaction scheme can be continued to form the star composition of matter dCum(PIB-b-PNBD-b-PIB-PNBD-Cl^{sec})₂ shown in formula ( ) by repeating the PIB-polymerization step and the NBD-polymerization step according to the illustrative reaction scheme:

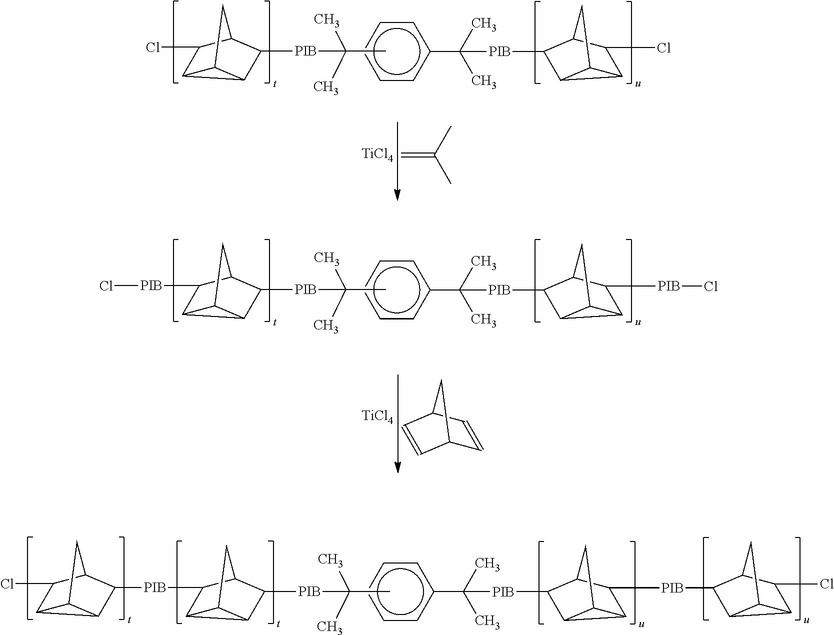

The length (Mₙ's) of the PIB segments and the polycycloolefin segments of each multiblock copolymer, and the arms formed therefrom, can be controlled by controlling the conditions of the living cationic polymerization of isobutylene and the living cationic polymerization of the polycycloolefin segments, respectively.

The compositions of matter of the present invention can be used for any applications that traditionally utilize thermoplastic elastomers, including, but not limited to adhesive and coating compositions comprising the compositions of matter disclosed herein.

### GENERAL EXPERIMENTATION

### Experiment 1

The following examples are set forth to describe the compositions of matter of the present invention in further detail, and to illustrate the methods of the present invention. The examples should not be construed as limiting the present invention in any manner. Throughout this specification and claims, all percentages are by weight and are based on the total composition of matter weight unless otherwise specifically stated.

The formation of the dCum(PIB-Cl^{t})₂ core from the difunctionalized dicumyl core is well known, and simply includes polymerization of isobutylene at the functionalized locations of the dicumyl core.

To illustrate the living polymerization of the polycycloolefin segments, the cationic polymerization of NBD is discussed. The conditions for polymerizing NB and the remaining polycycloolefin segments disclosed herein are similar, and therefore, do not require an additional detailed discussion. NBD, 2,6-di-tert-butylpyridine (“DtBP”), titanium tetrachloride (“TiCl₄”), all from Aldrich, were used as received. CH₂Cl₂ were purchased from Fisher. Isobutylene (chemically pure) was dried by the passage of the gas through columns packed with BaO, Drierite, and molecular sieves. CH₂Cl₂ was dried via refluxing over CaH₂ (Aldrich) for 4 days and was distilled before use.

Scheme 2 outlines the strategy for the synthesis of tCum(PIB-b-PNBD)3 and shows the structure of the three-arm star-block copolymer. Trimethyl 1,3,5-benzenetricarboxylate was converted to the corresponding alcohol 1,3,5-tris(2-hydroxylpropyl)benzene (“TCOH”). After recrystallization from ethyl acetate, the product was analyzed by 200 MHz H-NMR spectroscopy in a solution of CDCl₃/CD₃OD: δ=1.5 (s, 18H, 6CH₃); δ=7.4 (s, 3H, aromatic protons). Hydrochlorination of TCOH/methylene chloride solutions was effected by bubbling dry HCl through the charge at 0° C. for several hours. The solution was dried with MgSO₄, the CH₂Cl₂ was removed, and the product, tricumyl chloride (“TCC”), was recrystallized from n-hexane. H-NMR (CDCl₃): δ=2.0 (s, 18H, 6CH₃); δ=7.7 (s, 3H, aromatic protons).

The synthesis of three-arm star t-Cl-tritelechelic PIB precursors (“tCum(PIB-Cl^{t})₃”) was carried out by living isobutylene polymerization using a TCC/TiCl4/N,N-di-methylacetamide/−80° C. system. Allylation was achieved by end-quenching with allyltrimethylsilane. The tCum(PIB-Cl^{t})₃ was purified by multiple precipitations from hexanes into acetone. A similar procedure can be used to prepare the associated difunctional aromatic precursor dCum(PIB-Cl^{t})₂ by selecting the suitable difunctionalized aromatic starting material instead of the Trimethyl 1,3,5-benzenetricarboxylate.

Living cationic polymerization of NBD was carried out by the use of eight test tubes with: [NBD]₀=843 mM, [TMPCl]=18.15 mM, [DtBMP]=8.9 mM, [DMA]=32.7 mM, in 33 mL CH₃Cl at −60° F. The precooled coinitiator [TiCl4]=415 mM was added last. After given time intervals, the reactions were quenched with precooled methanol.

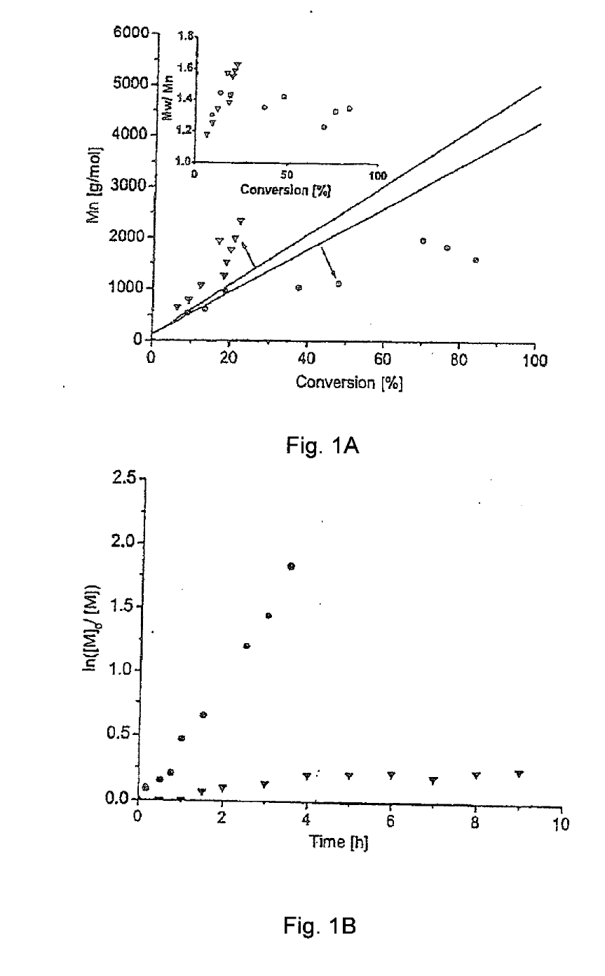

FIG. 1 shows a plot of the number-average molecular weight (Mₙ) v. conversion, which indicates conversion of lower than ˜20% (theoretical value), which is indicative of chain transfer in this region. The corresponding ln([M]ₒ/[M]) v. time plot is linear up to about 45 minutes, after which the rate increases significantly. The molecular-weight distribution (M_{w}/Mₙ) was generally constant at 1.35 over the entire conversion range (<84%). Based on these results, the system is considered living up to a conversion of about 20%.

### Experiment 2

Table 1 provides experimental conditions for cationically polymerizing block segments of PIB and the polycycloolefin segments from a dCum(PIB-Cl^{t})₂ core. DSC-analysis of the materials produced by these trials indicated the presence of the Tg's of the polycycloolefin segments, indicating phase separation. Results of this experiment are also tabulated in Table 1.

TABLE 1
Blocking NB and NBD from dCum (PIB—Cl^{t})₂

| | Conditions | Results | | | |
|---|---|---|---|---|---|
| | [dCum (PIB—Cl^{t})₂]/[Olefin]/[TiCl₄]/ | Star-Block | Mₙ | | T_{g,hard segment} |
| Olefin | [DtBP] (mmol/L); Solvent, T (° C.), t (h) | (g) | (g/mol) | M_{w}/Mₙ | (° C.) |
| 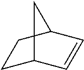 | 20.5/1380/400/112; CH₂Cl₂, −60, 3 | 3.4 g | 7.1 | 1.09 | 118 |
| 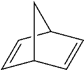 | 20.5/813/400/112; CH₂Cl₂, −60, 3 | 3.7 g | 9.1 | 1.07 | 218 |

### Experiment 3

Test tubes (50 mL) were charged with 30 mL of CH3Cl, 0.10 mL (0.599 mmol) of 2-Chloro-2,4,4-trimethylpentane (TMPCl), 60 mg (0.293 mmol) of 2,6-di-tert-butyl-4-methylpyridine (“DtBMP”), 0.10 mL (1.08 mmol) of N,N-dimethylacetamide (“DMA”), and 3 mL (27.8 mmol) of NBD at −60° C. To this mixture was added 4.5 mL of a precooled coinitiator solution [1.5 mL (13.68 mmol) of TiCl₄ in 3 mL of CH₃Cl]. The reactions were carried out with 50 mL test tubes with 25 or 33 mL of the solvent. The reactants were added sequentially as follows: the solvent or solvent mixture, the monomer (NBD), the initiator (TMPCl), the proton trap (DtBP or DtBMP), the electron donor (DMA), and the coinitiator (TiCl₄). After given time intervals, reactions were quenched with precooled methanol. Molecular weights, MWDs, and conversions were determined. Variations of the above-described experimental conditions are found in Table 2, along with the experimentally determined data.

TABLE 2

| | Conditions | | | | Results | | |
|---|---|---|---|---|---|---|---|
| | TMP-Cl | TiCl₄ | DtBP | DMA | Conversion | Mₙ | |
| Experiment | (mmol/L) | (mmol/L) | (mmol/L) | (mmol/L) | (%) | (g/mol) | M_{w}/Mₙ |
| 1 | 0.0 | 480 | 0.0 | 0.0 | Trace | — | — |
| 2 | 26.8 | 400 | 0.0 | 0.0 | 81 | 1.54 | |
| 3 | 26.8 | 480 | 16.7 | 0.0 | 34 | 2250 | 1.28 |
| 4 | 26.8 | 480 | 16.7 | 29.6 | 45 | 2730 | 1.21 |
| 5 | 26.8 | 480 | 0.0 | 29.6 | 29 | 2000 | 1.36 |
| 6 | 26.8 | 280 | 0.0 | 0.0 | 29 | 2050 | 1.97 |
| 7 | 26.8 | 280 | 0.0 | 25.8 | 9 | 1509 | 1.68 |
| 8 | 26.8 | 280 | 14.3 | 25.8 | 16 | 1543 | 1.47 |
| 9 | 26.8 | 280 | 14.3 | 25.8 | 22 | 2076 | 1.34 |
| 10 | 6.5 | 146 | 0.0 | 0.0 | 8 | 1490 | 2.38 |
| 11 | 6.5 | 146 | 4.5 | 0.0 | 14 | 1290 | 2.59 |
| 12 | 6.5 | 146 | 4.5 | 6.5 | 8 | 828 | 2.30 |
| 13 | 6.5 | 146 | 0.0 | 6.5 | 7 | 912 | 2.30 |

^{a}Experiments 1-9: 5 mL (1.6M) of NBD; experiments 10-13; 4 mL. (1.28M) of NBD; all experiments: 25 mL of CH₃Cl, T = −60° C., t = 2 h.

### Thermal Properties

T_{g}'s were determined with a differential scanning calorimeter (model DSC 2910, DuPont Instruments) under N₂. Samples were heated to 300° C. at 10° C./min to remove thermal history effects and were cooled to −100° C. Thermograms were recorded via reheating to 300° C. at 10° C./min.

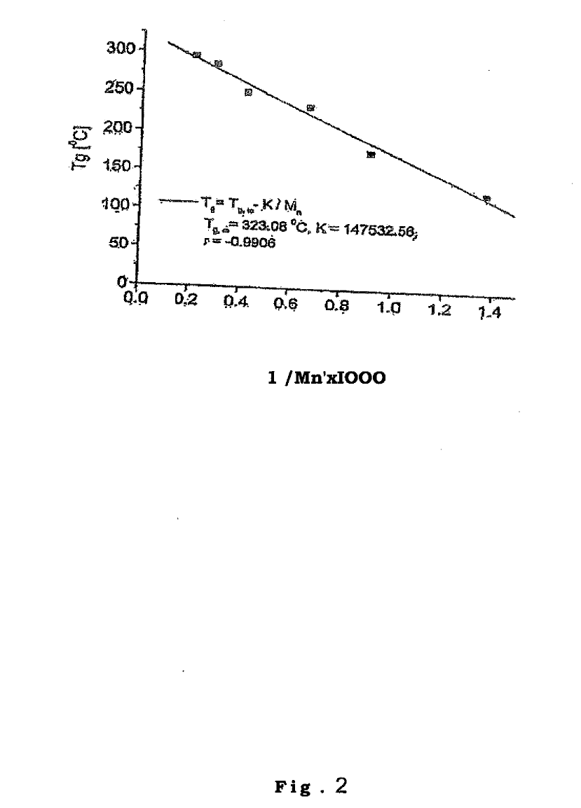

Thermal degradation was studied with a thermogravimetric analyzer (Model HI-Res TGA 2950) by the heating of samples from ambient temperature to 400° C. at 10° C./min. under N₂. It was observed that the T_{g,∞} of the cationically-polymerized PNBD was about 323° C. and K=14.75×10⁴, wherein T_{g,∞} is the glass-transition temperature of the infinite molecular weight polymer and K is a characteristic material constant. FIG. 2 shows the relationship of T_{g} of PNBD v. 1/Mₙ.

What is claimed as the invention is:

1. A multi-arm star block copolymer composition of matter comprising:
an aromatic core having one or more arms extending therefrom;
wherein each of the one or more arms are formed from a polyisobutylene segment and a cycloolefin or polycycloolefin segment,
wherein the polyisobutylene segment and the cycloolefin or polycycloolefin segment form a repeating unit multiblock copolymer,
wherein the cycloolefin or polycycloolefin segment is selected from one or more of the following formulas that is derived from a corresponding norbornadiene compound: 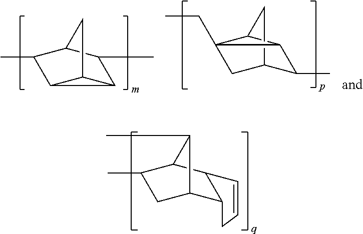
wherein n, m, p and q are all independently-selected integers that are at least 1.

2. The composition of matter according to claim 1, further comprising an aromatic core from which two arms extend, wherein each arm comprises the PIB segment and the cycloolefin or polycycloolefin segment.

3. The composition of matter according to claim 2, wherein each of the arms comprises the same copolymer.

4. The composition of matter according to claim 2, wherein each of the arms is obtained by a living cationic polymerization process.

5. The composition of matter according to claim 2, wherein the composition of matter is represented by the formula selected from the one or more of the following formulas: 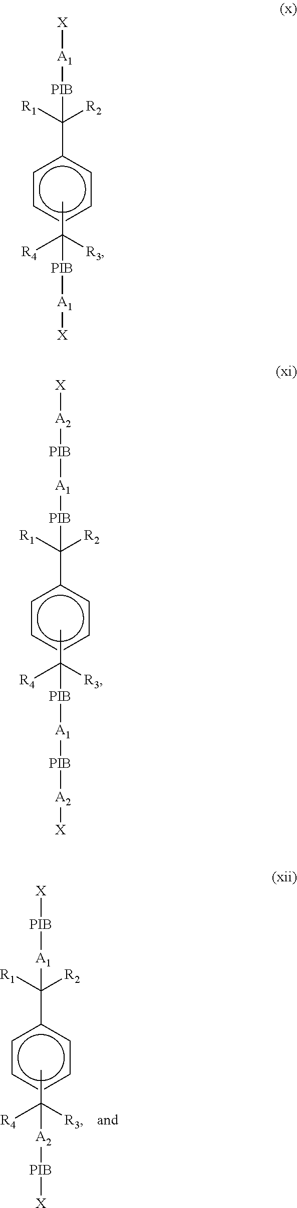 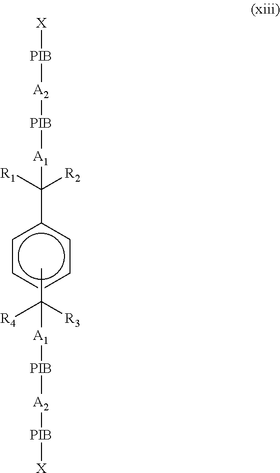
wherein A₁ and A₂ are independently-selected cycloolefin or polycycloolefin segments;
wherein R₁ to R₄ are each independently selected from hydrogen, a methyl group, an ethyl group, and a phenyl group; and
wherein X is selected from —Cl, —Br, —OH, —OCH₃, —OCH₂CH₃, and —OCOCH₃.

6. The composition of matter according to claim 1, further comprising an aromatic core from which three arms extend, wherein each arm comprises the PIB segment and the cycloolefin or polycycloolefin segment.

7. The composition of matter according to claim 1, wherein the polyisobutylene segment and the cycloolefin or polycycloolefin segment are arranged according to the formula: 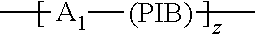
wherein Z is an integer that is at least 1, and wherein A₁ is the cycloolefin or polycycloolefin segment.

8. The composition of matter according to claim 1, wherein the polyisobutylene segment and the polycycloolefin segment are arranged according to the formula: 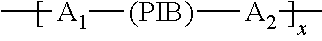
wherein X is an integer that is at least 1, and wherein A₁ and A₂ are independently selected cycloolefin or polycycloolefin segments.

9. A thermoplastic elastomer comprising the composition of matter according to claim 1.

10. An adhesive composition comprising the composition of matter according to claim 1.

11. A coating composition comprising the composition of matter according to claim 1.

12. A method of preparing a composition of matter, the process comprising the steps of:
providing a bifunctional aromatic core;
reacting the bifunctional aromatic core with isobutylene to form a macroinitiator having two arms, said macroinitiator comprising polyisobutylene functionalized at the terminus of each arm;
adding a functional group to the terminus of each arm of the macroinitiator to introduce an active site capable of initiating cationic polymerization of block polymer segments at the terminus of each arm; and
initiating cationic polymerization to form the block polymer segments of each arm, thereby forming a multi-arm star composition of matter having multiblock copolymer arms,
wherein the cationic polymerization step involves the cationic polymerization of a norbornadiene compound.

13. The method according to claim 12, wherein the step of initiating cationic polymerization comprises the step of:
cationically polymerizing the multiblock arms, wherein the arms comprise the general formula: 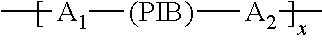
wherein PIB is a polyisobutylene segment;
wherein A₁ and A₂ are cycloolefin or polycycloolefin segment independently selected from one or more of the following formulas: 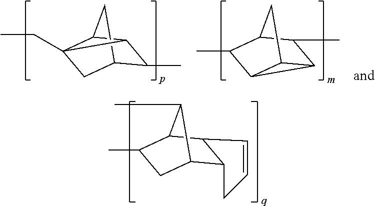
wherein n, m, p and q are all independently-selected integers that are at least 1.

14. The method according to claim 12, wherein the bifunctional aromatic core is a dicumyl core.

15. The method according to claim 12 further comprising the step of providing a functional group at a terminus of each arm to terminate polymerization of the arms.

16. The method according to claim 15, wherein the functional group is selected from —Cl, —Br, —OH, —OCH₃, —OCH₂CH₃, and —OCOCH₃.

17. A thermoplastic elastomer produced by the process of claim 12.

18. An adhesive produced by the method of claim 12.

19. A coating produced by the process of claim 12.

20. A composition of matter comprising:
a polyisobutylene segment and a cycloolefin or polycycloolefin segment,
wherein the polyisobutylene segment and the cycloolefin or polycycloolefin segment form a repeating unit multiblock copolymer,
wherein the cycloolefin or polycycloolefin segment is derived from a norbornadiene compound as is selected from one or more of the following formulas: 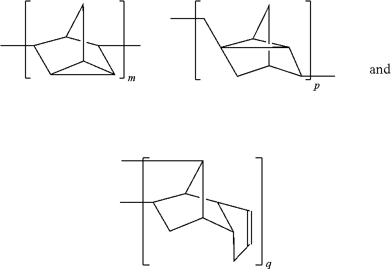
wherein m, p and q are all independently-selected integers that are at least 1.

21. The composition of matter according to claim 20, further comprising an aromatic core from which two arms extend, wherein each arm comprises the PIB segment and the cycloolefin or polycycloolefin segment.

22. The composition of matter according to claim 21, wherein each of the arms comprises the same copolymer.

23. The composition of matter according to claim 21, wherein each of the arms is obtained by a living cationic polymerization process.

24. The composition of matter according to claim 21, wherein the composition of matter is represented by the formula selected from the one or more of the following formulas: 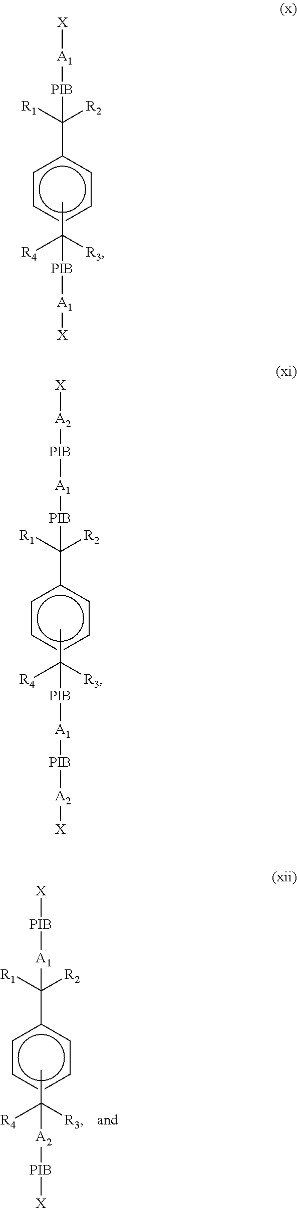 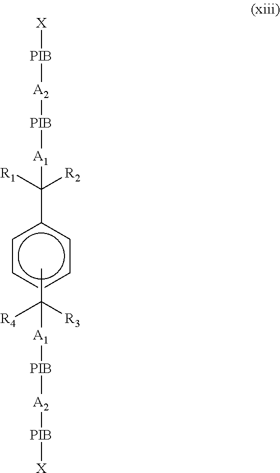
wherein A₁ and A₂ are independently-selected cycloolefin or polycycloolefin segments;
wherein R₁ to R₄ are each independently selected from hydrogen, a methyl group, an ethyl group, and a phenyl group; and
wherein X is selected from —Cl, —Br, —OH, —OCH₃, —OCH₂CH₃, and —OCOCH₃.

25. The composition of matter according to claim 20, further comprising an aromatic core from which three arms extend, wherein each arm comprises the PIB segment and the cycloolefin or polycycloolefin segment.

26. The composition of matter according to claim 20, wherein the polyisobutylene segment and the cycloolefin or polycycloolefin segment are arranged according to the formula: 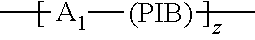
wherein Z is an integer that is at least 1, and wherein A₁ is the cycloolefin or polycycloolefin segment.

27. The composition of matter according to claim 20, wherein the polyisobutylene segment and the polycycloolefin segment are arranged according to the formula: 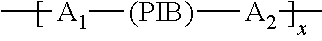
wherein X is an integer that is at least 1, and wherein A₁ and A₂ are independently selected cycloolefin or polycycloolefin segments.

28. A thermoplastic elastomer comprising the composition of matter according to claim 20.

29. An adhesive composition comprising the composition of matter according to claim 20.

30. A coating composition comprising the composition of matter according to claim 20.
